(19) United States
(12) Patent Application Publication
(10) Pub. No.: US 2007/0071868 A1
(43) Pub. Date: Mar. 29, 2007

(54) Apparatus for the selectively shrinking a film wrapped around a product

(76) Inventor: Iosu Errasti Iriarte, Eskoriatza (ES)

Correspondence Address: KEITH KLINE;THE KLINE LAW FIRM, 161 LITTLE POND LANE, PALMYRA, VA, 22963, US

(21) Appl. No.: 10/580,012

(22) PCT Filed: Oct. 20, 2004
(86) PCT No.: PCT/ES04/00451

§ 371 Date: May 19, 2006

(30) Foreign Application Priority Data
Oct. 27, 2003 (ES) P 200302510

(51) Int. Cl. A23C 19/00

(52) U.S. Cl. 426/582

(57) ABSTRACT

The invention relates to an apparatus for selectively shrinking a film, which is wrapped around a product (P), comprising a frame (9), a driven conveyor (1) mounted on said frame (9) and intended to transport sequentially a plurality of products (P), a heat source (5) arranged under the conveyor (1) and which generates a hot fluid, and a plurality of nozzles (5.1) oriented towards the low part of said conveyor (1), the hot fluid being provided to said nozzles (5.1). The heat source (5) and the nozzles (5.1) are fixed and the apparatus also comprises closing means by means of which the hot fluid reaches only the front and rear ends of each product (P).

### TECHNICAL FIELD

The present invention relates to apparatuses for shrinking a heat shrinkable film wrapped around a product, and more specifically to apparatuses for shrinking only certain parts of the film wrapped around each product.

### PRIOR ART

Within the product packaging industry there are several known shrinking procedures used to wrap products with thermically shrinkable films. More specifically, there are known procedures for packaging food products, mainly meat, positioned on a prefabricated tray.

In said packaging procedures the products are positioned on the tray and are wrapped with the film from a reel of film by means of three seams: a front transverse seam, a rear transverse seam and a longitudinal seam. The wrapped product is then conveyed through an apparatus that shrinks the film making it adapt to the shape of the product and the tray. Said shrinking is performed by applying on the wrapped product, which is conveyed along a conveyor, a hot fluid that is typically a gas, such as air or steam, or a liquid, such as water.

Official regulations require that packaged products include printed information on the expiry and the product storage date. This information is preferably printed on the part of the film in contact with the bottom of the tray. If, due to the application of the hot fluid, said part of the film also shrinks, the printed portion is frequently distorted and becomes illegible.

This problem is resolved by applying the hot fluid to the front and rear transverse ends of each tray only. U.S. Pat. No. 5,546,677 describes an apparatus that achieves this by making the trays rotate 90° and making them move so that heat sources disposed longitudinally on both sides of the conveyor act upon the transverse ends of each tray.

ES 2 182 301 T3 describes an apparatus that resolves this and other problems. Said apparatus, in order to apply the hot fluid to the front and rear transverse ends of the tray only, is based on the coordinated movement of the heat sources in relation to the movement of the trays on the conveyor.

### DISCLOSURE OF THE INVENTION

The main object of the invention is to provide an apparatus for shrinking a film wrapped around a product so that the hot fluid is applied to the front and rear transverse ends of the product only without the need for moving the heat sources.

The inventive apparatus comprises a frame, a driven conveyor, mounted on said frame, on which are sequentially transported a plurality of products, a heat source disposed underneath the conveyor and which generates a hot fluid, and a plurality of nozzles oriented towards the bottom of said conveyor, the hot fluid being transmitted through said nozzles.

The heat source and the nozzles are fixed, and the apparatus also comprises closing means through which the hot fluid passes to the front and rear ends of each product only so that only said part of the film is shrunk, thereby preventing the distortion of the adjacent areas.

By making both the heat source and the nozzles fixed, a simpler apparatus and therefore an apparatus that is more economical and is easier to maintain and repair is achieved. Furthermore, the inventive apparatus enables work to be performed at a greater speed than in apparatuses in which the nozzles follow the trays, as it is not restricted by the speed of movement of the nozzles or by the time they need to return to their initial position.

These and other advantages and characteristics of the invention will be made evident in the light of the drawings and the detailed description thereof.

### DESCRIPTION OF THE DRAWINGS

FIG. 1 is an elevation view of an embodiment of the inventive apparatus.

FIG. 2 is a perspective view of part of the embodiment of FIG. 1.

FIG. 3 is a partial view in detail of the embodiment of FIG. 1.

FIG. 4 is a more detailed view of FIG. 3. FIG. 5 is an elevation and plan view of a second embodiment of the inventive apparatus.

FIG. 6 is an elevation view of a third embodiment of the invention.

### DETAILED DISCLOSURE OF THE INVENTION

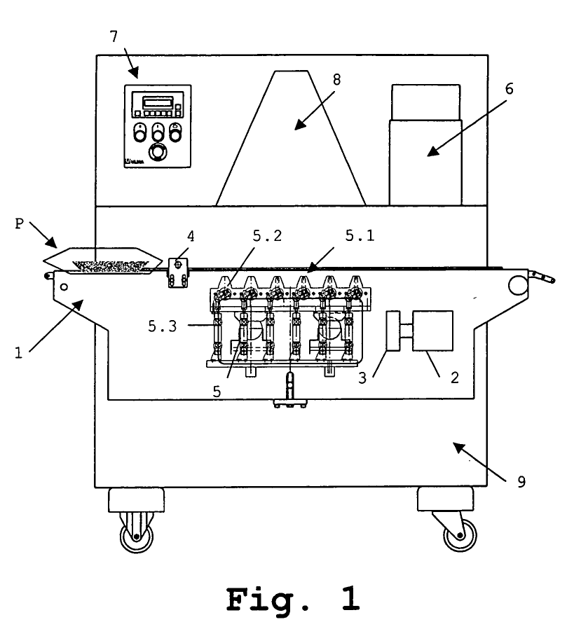

As FIG. 1 shows, by means of the inventive apparatus a film wrapped around a product P is shrunk, and said apparatus comprises:
a frame 9,
a driven conveyor 1, mounted on said frame 9, on which are sequentially transported a plurality of products P,
a heat source 5 disposed underneath the conveyor 1 and which generates a hot fluid, and
a plurality of nozzles 5.1 oriented towards the bottom of said conveyor 1, with the hot fluid being conveyed to said nozzles 5.1.

The heat source 5 and the nozzles 5.1 are fixed, and the apparatus also comprises closing means through which the hot fluid is allowed to pass to the front and rear transverse ends of each product P only.

With reference to FIG. 1, the shrinking process is controlled by a microprocessor 7. The conveyor 1 is driven for example by a three-phase geared motor 2 that has an encoder 3. The apparatus also comprises a photocell 4 that detects the product P. Therefore, depending on the signals that the microprocessor 7 receives from the encoder 3 and from the photocell 4, and depending on the dimensions of the product P, said microprocessor 7 knows at which moments the front or rear transverse end of a product P is situated above each of the nozzles 5.1. Therefore, the microprocessor 7 allows the passage of the hot fluid only at those moments.

The microprocessor 7 ensures that each and every one of the nozzles 5.1 contributes to the shrinking of each transverse end of each product P, and consequently, by increasing the number of nozzles 5.1 used, it is possible to convey the products P along the conveyor 1 at a greater speed, thereby increasing the number of products P packaged per time unit.

In a preferred embodiment, the heat source 5 comprises a blower and a plurality of electrical air heaters (not shown in the figures) connected to the nozzles 5.1. The microprocessor 7 controls the flow of said heat source 5.

The inventive apparatus also comprises, after the nozzles 5.1, a second heat source 6 disposed on the conveyor 1 to shrink the film on the top of the products P. In addition, the inventive apparatus comprises an extractor hood 8 to prevent the concentration of heat around the product P, which may damage the localised shrinking of the film.

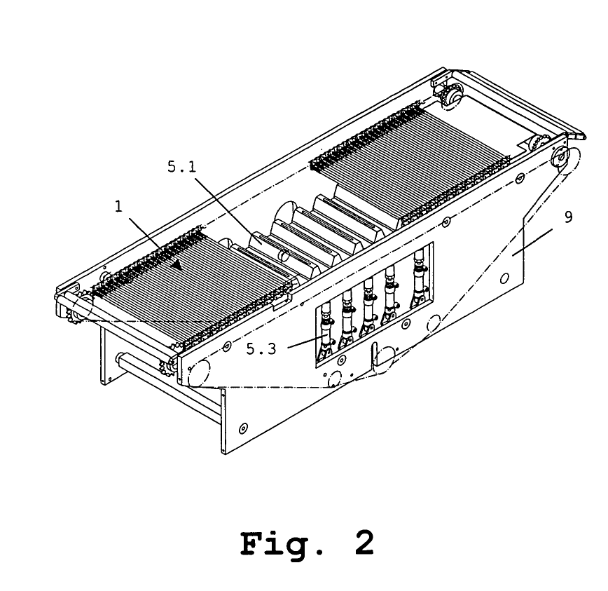

In the embodiment in FIGS. 1 to 4, the closing means of the nozzles 5.1 comprise moving means 5.2 on each of the nozzles 5.1, with said moving means 5.2 pivoting, in order to enable or prevent the passage of hot fluid, in relation to an axis 5.5 parallel to the plane of the conveyor 1.

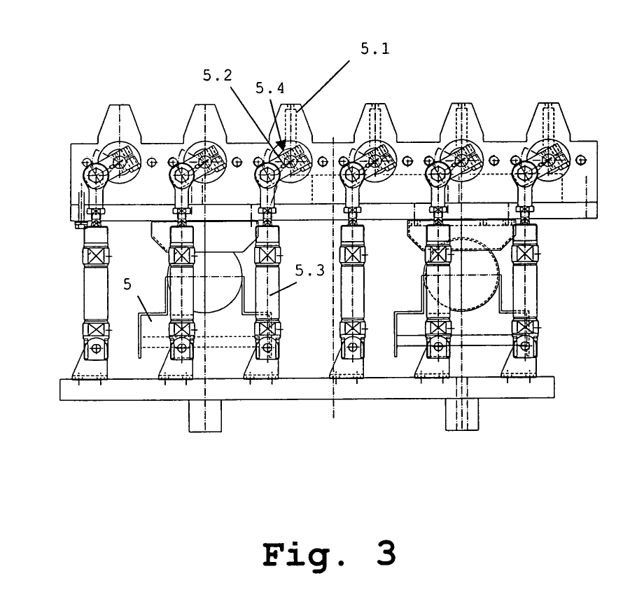

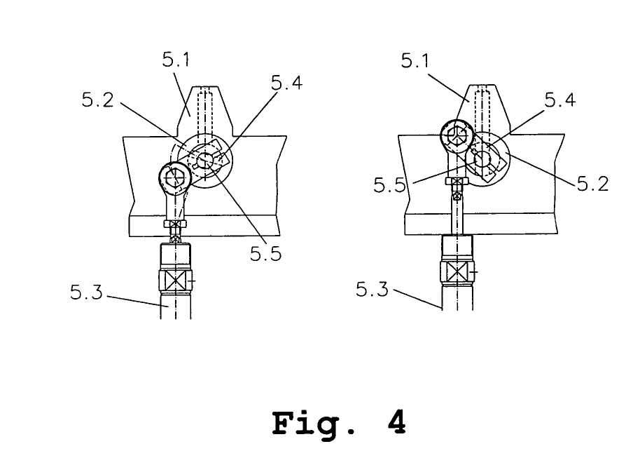

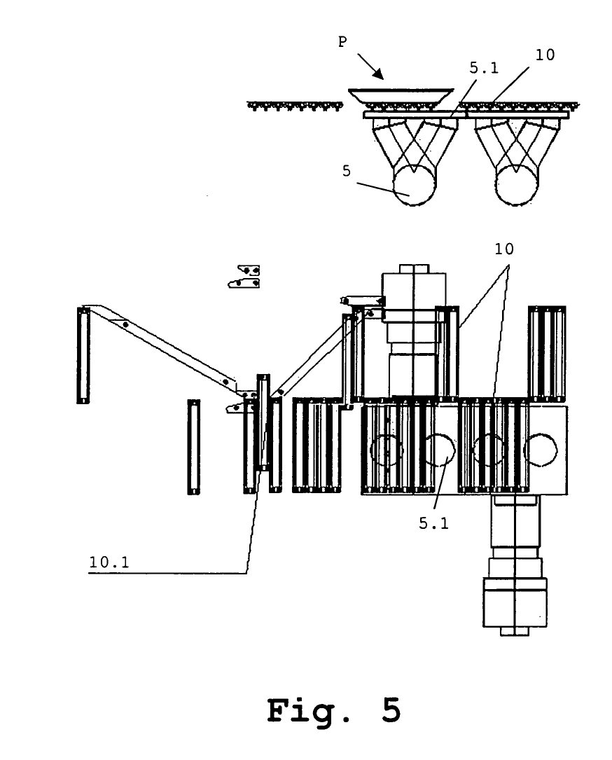

More specifically, as shown in FIGS. 3 and 4, in this embodiment the closing means comprise, for each nozzle 5.1, an arm 5.3 connected to the moving means 5.2 and which move said moving means 5.2. The moving means 5.2 comprise a conduit 5.4 so that when the moving means 5.2 are in such a position that said conduit 5.4 is aligned with the outlet conduit on the corresponding nozzle 5.1, hot fluid is allowed to pass through the outlet conduit on said nozzle 5.1.

In this embodiment, the moving means 5.2 have a substantially cylindrical form and extend all the way along the nozzles 5.1. In the position shown in FIG. 3, the conduits 5.4 are not aligned with the outlet conduits on the nozzles 5.1. FIG. 4 shows the moving means 5.2 in their two positions: in the closed position on the left, and in the open position on the right, i.e. with the conduit 5.4 aligned with the outlet conduit on the nozzle 5.1. It can be seen how it moves from one position to another causing the moving means 5.2 to pivot in relation to the axis 5.5 by means of the corresponding arm 5.3.

In a second embodiment, shown in FIG. 5, the closing means on the nozzles 5.1 comprise a plurality of shutters 10 disposed transversally on the conveyor 1, and means 10.1 for selectively removing said shutters 10 from the conveyor 1 to allow the passage of hot fluid from the nozzles 5.1 to the front and rear transverse ends of each product P.

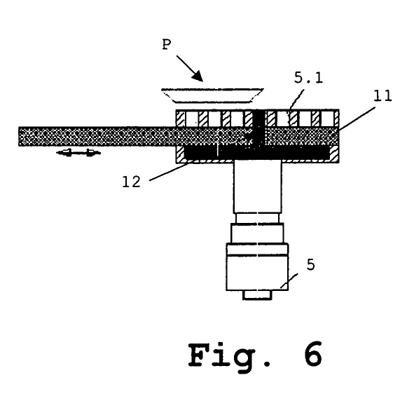

In a third embodiment, shown in FIG. 6, the closing means comprise a plate 11 between the heat source 5 and the nozzles 5.1. Said plate 11 can be moved transversally in relation to the heat source 5 and the nozzles 5.1, and comprises at least one orifice 12. In this embodiment, the passage of the hot fluid from the nozzles 5.1 to the bottom part of the conveyor 1 is allowed, with the orifice 12 being aligned selectively with each nozzle 5.1.

1. An apparatus for selectively shrinking a film wrapped around a product (P), that comprises
a frame (9),
a driven conveyor (1), mounted on said frame (9), on which a plurality of products (P) are sequentially transported,
a heat source (5) disposed underneath the conveyor (1) and which generates a hot fluid, and
a plurality of nozzles (5.1) oriented towards the bottom of said conveyor (1), with the hot fluid being conveyed to said nozzles (5.1),
wherein the heat source (5) and the nozzles (5.1) are fixed, and the apparatus also comprises closing means through which the hot fluid is allowed to pass to the front and rear ends of each product (P) only.

2. The apparatus according to claim 1, wherein the closing means comprise moving means (5.2) on each of the nozzles (5.1), said moving means (5.2) pivoting to enable or prevent the passage of hot fluid in relation to an axis (5.5) parallel to the plane of the conveyor (1).

3. The apparatus according to claim 2, wherein the moving means (5.2) comprise a conduit (5.4) that is aligned with the outlet conduit on each nozzle (5.1) to allow the passage of hot fluid.

4. The apparatus according to claim 3, wherein said apparatus further comprises for each nozzle (5.1), an arm (5.3) connected to the moving means (5.2), said arm (5.3) moving the corresponding moving means (5.2) in relation to the axis (5.5).

5. The apparatus according to claim 1, wherein the closing means comprise a plurality of shutters (10) disposed transversely on the conveyor (1), and means (10.1) for selectively removing said shutters (10) from the conveyor (1) to allow the passage of hot fluid from the nozzles (5.1) to the front and rear transverse ends of each product (P).

6. The apparatus according to claim 1, wherein the closing means comprise a plate (11) between the heat source (5) and the nozzles (5.1), the plate (11) being able to move transversely in relation to the heat source (5) and the nozzles (5.1), and said plate (11) comprising at least one orifice (12), so that the passage of the hot fluid is enabled aligning the orifice (12) selectively with each nozzle (5.1).
